(19) United States
(12) Patent Application Publication
(10) Pub. No.: US 2012/0116606 A1
(43) Pub. Date: May 10, 2012

(54) RANGE DISPLAY APPARATUS

(75) Inventor: Jyunpei ICHINOKAWA, Wako (JP)

(73) Assignee: HONDA MOTOR CO., LTD., Tokyo (JP)

(21) Appl. No.: 13/280,377

(22) Filed: Oct. 25, 2011

(30) Foreign Application Priority Data
Nov. 4, 2010 (JP) 2010-247480

(51) Int. Cl. G06F 7/00

(52) U.S. Cl. 701/1

(57) ABSTRACT

A range display apparatus includes a range calculator, an amount-of-consumption calculator, a remaining-amount-of-electricity calculator, a full-charge detector, an average mileage calculator, an instantaneous mileage calculator, a current possible range calculator, an instantaneous possible range calculator, a current total range calculator, an instantaneous total range calculator, a storage device, and a display. The current total range calculator is configured to calculate a current total range. The instantaneous total range calculator is configured to calculate an instantaneous total range. The storage device is configured to store the current total range calculated by the current total range calculator when the full-charge detector has detected a full charge as a past total range. The display is configured to display the current total range, the instantaneous total range, and the past total range.

### CROSS-REFERENCE TO RELATED APPLICATIONS

The present application claims priority under 35 U.S.C. §119 to Japanese Patent Application No. 2010-247480, filed Nov. 4, 2010, entitled “Range display apparatus.” The contents of this application are incorporated herein by reference in their entirety.

### BACKGROUND OF THE INVENTION

1. Field of the Invention

The present invention relates to a range display apparatus.

2. Discussion of the Background

The moving body is applicable to, for example, a plug-in hybrid vehicle and a pleasure boat, in addition to a vehicle, particularly, an electric vehicle.

Range display apparatuses that display possible ranges in display units provided in vehicles have hitherto been proposed.

Japanese Examined Patent Application Publication No. 58-38726 discloses a method of displaying a vehicle possible range, in which it is determined whether the remaining amount of fuel of a vehicle is not larger than a predetermined amount. In the above method, the possible range is calculated on the basis of a past average mileage for display if the remaining amount of fuel is larger than the predetermined amount, and the possible range is calculated on the basis of an update mileage that results from addition of information about an instantaneous mileage for every predetermined time to the average mileage to be sequentially updated for display if the remaining amount of fuel is smaller than the predetermined amount.

Japanese Unexamined Patent Application Publication No. 2001-236054 discloses a method (apparatus) of alternately displaying an attained distance (possible attained distance) and the remaining distance to a destination at the same portion in a display unit and a method (apparatus) of optically displaying information about an automobile, in which an instantaneous mileage and an average mileage are alternately displayed at the same portion in the display unit, in addition to a method (apparatus) of alternately displaying a remaining amount of fuel and the attained distance (possible attained distance) at the same portion in the display unit.

Electric vehicles (EVs) that are driven by the power of motors receiving supply of electric power from batteries are proposed in recent years. Since the electric vehicles are capable of being charged by, for example, individuals by using excessive midnight power, the energy cost can be reduced with the electric vehicles. The electric vehicles have the advantage of, for example, higher energy efficiency, compared with engines (internal combustion engines).

### SUMMARY OF THE INVENTION

According to one aspect of the present invention, a range display apparatus includes a range calculator, an amount-of-consumption calculator, a remaining-amount-of-electricity calculator, a full-charge detector, an average mileage calculator, an instantaneous mileage calculator, a current possible range calculator, an instantaneous possible range calculator, a current total range calculator, an instantaneous total range calculator, a storage device, and a display. The range calculator is configured to calculate a range. The amount-of-consumption calculator is configured to calculate an amount of consumption of a battery. The remaining-amount-of-electricity calculator is configured to calculate a remaining amount of electricity of the battery. The full-charge detector is configured to detect full charge of the battery. The average mileage calculator is configured to calculate an average mileage based on a first range from full charge and a first amount of consumption from full charge. The first range is a range from a time when the full-charge detector has detected the full charge to a current time. The first amount of consumption is an amount of consumption from a time when the full-charge detector has detected the full charge to the current time. The instantaneous mileage calculator is configured to calculate an instantaneous mileage based on an instantaneous value of the range calculated by the range calculator and an instantaneous value of the amount of consumption calculated by the amount-of-consumption calculator. The current possible range calculator is configured to calculate a current possible range based on the average mileage calculated by the average mileage calculator and the remaining amount of electricity calculated by the remaining-amount-of-electricity calculator. The instantaneous possible range calculator is configured to calculate an instantaneous possible range based on the instantaneous mileage calculated by the instantaneous mileage calculator and the remaining amount of electricity. The current total range calculator is configured to calculate a current total range. The current total range is a sum of the first range and the current possible range. The instantaneous total range calculator is configured to calculate an instantaneous total range. The instantaneous total range is a sum of the first range and the instantaneous possible range. The storage device is configured to store the current total range calculated by the current total range calculator when the full-charge detector has detected the full charge as a past total range. The display is configured to display the current total range, the instantaneous total range, and the past total range such that the current total range, the instantaneous total range, and the past total range are compared with each other.

According to another aspect of the present invention, a range display apparatus includes a range calculator, an amount-of-consumption calculator, a remaining-amount-of-electricity calculator, a full-charge detector, an average mileage calculator, a current possible range calculator, a current total range calculator, a storage device, and a display. The range calculator is configured to calculate a range. The amount-of-consumption calculator is configured to calculate an amount of consumption of a battery. The remaining-amount-of-electricity calculator is configured to calculate a remaining amount of electricity of the battery. The full-charge detector is configured to detect full charge of the battery. The average mileage calculator is configured to calculate an average mileage based on a first range from full charge and a first amount of consumption from full charge. The first range is a range from a time when the full-charge detector has detected the full charge to a current time. The first amount of consumption is an amount of consumption from a time when the full-charge detector has detected the full charge to the current time. The current possible range calculator is configured to calculate a current possible range based on the average mileage calculated by the average mileage calculator and the remaining amount of electricity calculated by the remaining-amount-of-electricity calculator. The current total range calculator is configured to calculate a current total range. The current total range is a sum of the first range and the current possible range. The storage device is configured to store the current total range calculated by the current total range calculator when the full-charge detector has detected the full charge as a past total range. The display is configured to display the current total range and the past total range such that the current total range and the past total range are compared with each other.

According to further aspect of the present invention, a range display apparatus includes a range calculator, an amount-of-consumption calculator, a remaining-amount-of-electricity calculator, a full-charge detector, an average mileage calculator, a current possible range calculator, a storage device, and a display. The range calculator is configured to calculate a range. The amount-of-consumption calculator is configured to calculate an amount of consumption of a battery. The remaining-amount-of-electricity calculator is configured to calculate a remaining amount of electricity of the battery. The full-charge detector is configured to detect full charge of the battery. The average mileage calculator is configured to calculate an average mileage based on a first range from full charge and a first amount of consumption from full charge. The first range is a range from a time when the full-charge detector has detected the full charge to a current time. The first amount of consumption is an amount of consumption from a time when the full-charge detector has detected the full charge to the current time. The instantaneous mileage calculator is configured to calculate an instantaneous mileage based on an instantaneous value of the range calculated by the range calculator and an instantaneous value of the amount of consumption calculated by the amount-of-consumption calculator. The current possible range calculator is configured to calculate a current possible range based on the average mileage calculated by the average mileage calculator and the remaining amount of electricity calculated by the remaining-amount-of-electricity calculator. The instantaneous possible range calculator is configured to calculate an instantaneous possible range based on the instantaneous mileage calculated by the instantaneous mileage calculator and the remaining amount of electricity. The current total range calculator is configured to calculate a current total range. The current total range is a sum of the first range and the current possible range. The instantaneous total range calculator is configured to calculate an instantaneous total range. The instantaneous total range is a sum of the first range and the instantaneous possible range. The storage device is configured to store the current total range calculated by the current total range calculator when the full-charge detector has detected the full charge as a past total range. The display is configured to display the instantaneous total range and the past total range such that the instantaneous total range and the past total range are compared with each other.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a schematic plan view of an electric vehicle in which a range display apparatus according to a first embodiment of the present invention is mounted;

FIG. 2 is a schematic side view of the electric vehicle in FIG. 1;

FIG. 3 is a functional block diagram illustrating an example of the configuration of the range display apparatus according to the first embodiment of the present invention;

FIG. 4 illustrates an example of display in the first embodiment of the present invention;

FIG. 5 illustrates an example of how the range display apparatus of the first embodiment of the present invention is used;

FIG. 6 illustrates another example of how the range display apparatus of the first embodiment of the present invention is used;

FIG. 7 illustrates an example of display according to a first modification;

FIG. 8 illustrates an example of display according to a second modification;

FIG. 9 illustrates another example of display according to the second modification;

FIG. 10 is a functional block diagram illustrating an example of the configuration of a range display apparatus according to a second embodiment of the present invention; and

FIG. 11 illustrates an example of display in the second embodiment of the present invention.

### DESCRIPTION OF THE EMBODIMENTS

The embodiments will now be described with reference to the accompanying drawings, wherein like reference numerals designate corresponding or identical elements throughout the various drawings.

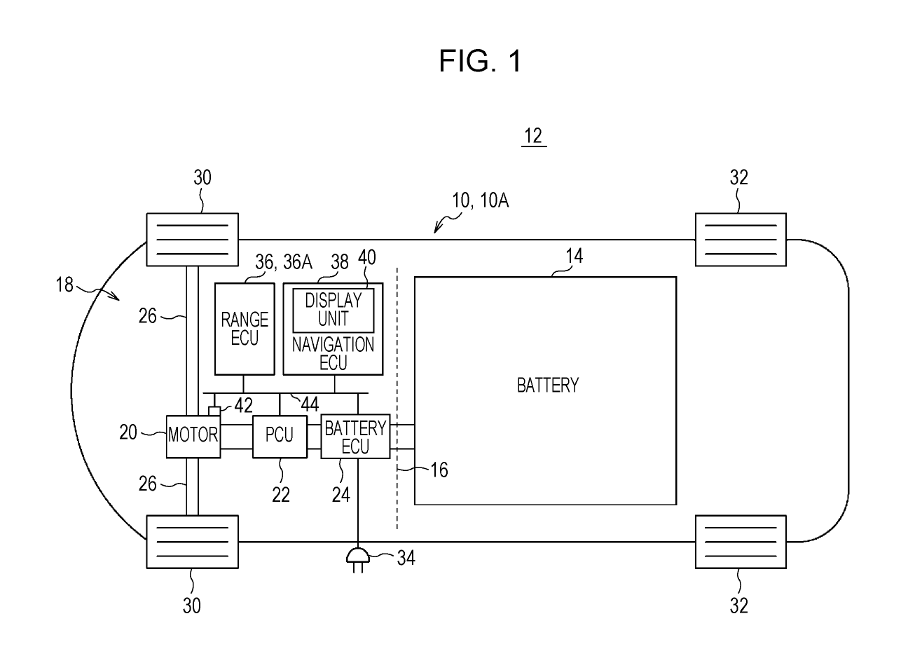

FIG. 1 is a schematic plan view of an electric vehicle 12 (a moving body) in which a range display apparatus 10 according to a first embodiment of the present invention is mounted.

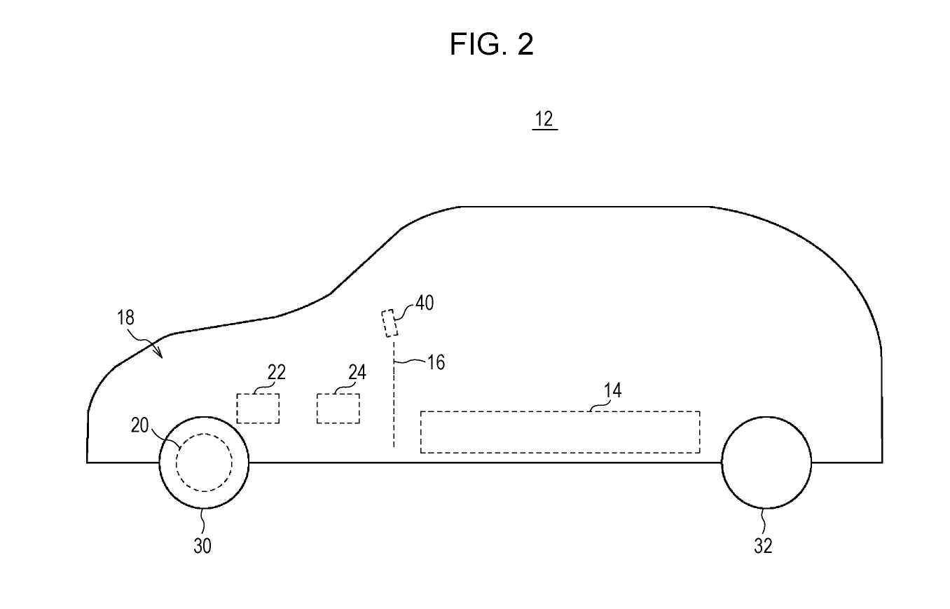

FIG. 2 is a schematic side view of the electric vehicle 12 in FIG. 1.

Referring to FIG. 1 and FIG. 2, a battery 14 (storage battery) is arranged under the floor under seats (not shown) of the electric vehicle 12. A motor assembly 20 (hereinafter simply referred to as a motor 20), a power conversion unit (PCU) 22, a battery electronic control unit (ECU) 24, a range ECU 36, etc. are basically arranged in a motor room 18 in front of a dashboard lower panel 16 of the electric vehicle 12. The motor 20 includes a rotating electric machine (motor/generator) and a transmission. The power conversion unit 22 includes an ECU and an inverter controlled by the ECU. The battery ECU 24 controls charge and discharge of the battery 14. The range ECU 36 calculates various ranges of the electric vehicle 12.

In power running in which the motor 20 functions as the motor, the electric power from the battery 14 is converted into power via the battery ECU 24, the power conversion unit 22, and the motor 20 and the power is used to rotate front wheels 30, which are driving wheels, via an axle 26. In the present embodiment, rear wheels 32 are coupled driving wheels. In regeneration in which the motor 20 functions as the generator, the battery 14 is charged with the power supplied from the motor 20 via the power conversion unit 22 and the battery ECU 24.

The battery ECU 24 includes a charger and controls the charge from an external charge stand to the battery 14 via a power-supply plug 34.

In the present embodiment, the range display apparatus 10 includes a vehicle-speed pulse sensor 42 mounted to the motor 20, the battery ECU 24, the range ECU 36, and a display unit 40. The vehicle-speed pulse sensor 42 may be replaced with four vehicle-speed pulse sensors mounted to the respective front wheels 30 and the respective rear wheels 32.

The vehicle-speed pulse sensor 42, the power conversion unit 22, the battery ECU 24, a navigation ECU 38, and the range ECU 36 are connected to each other via a communication line 44.

Each ECU includes a timer, a sensor, and a computer and also serves as a function realizing unit in which a central processing unit (CPU) executes programs stored in, for example, a read only memory (ROM) on the basis of various inputs to realize various functions.

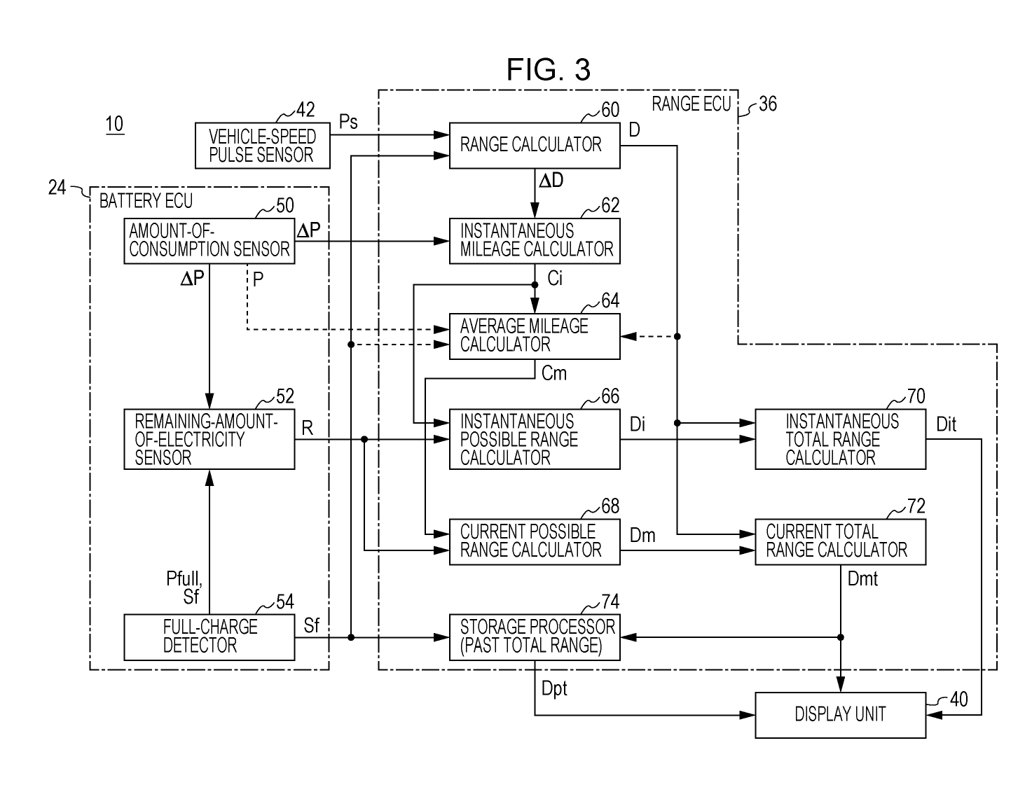

FIG. 3 is a functional block diagram illustrating an example of the configuration of the range display apparatus 10.

Referring to FIG. 3, the battery ECU 24 includes an amount-of-consumption sensor 50, a remaining-amount-of-electricity sensor 52, and a full-charge detector 54. The amount-of-consumption sensor 50 calculates an amount of consumption ΔP [Ah] for every predetermined time (one second in the present embodiment) of the battery 14. The remaining-amount-of-electricity sensor 52 calculates a remaining amount of electricity R [Ah] of the battery 14 on the basis of a full-charge amount of electricity Pfull [Ah] and the amount of consumption ΔP [Ah] in synchronization with the predetermined time. The full-charge detector 54 detects full charge of the battery 14 to output a full-charge detection signal Sf and the full-charge amount of electricity Pfull [Ah].

The range ECU 36 includes a range calculator 60, an instantaneous mileage calculator 62, an average mileage calculator 64, an instantaneous possible range calculator 66, a current possible range calculator 68, an instantaneous total range calculator 70, a current total range calculator 72, and a storage processor 74.

The range calculator 60 calculates a range ΔD [km] for every predetermined time (one second in the present embodiment) on the basis of a vehicle-speed pulse Ps supplied from the vehicle-speed pulse sensor 42 in synchronization with the predetermined time and calculates a range D [km] from full charge since the full-charge detector 54 has detected the full-charge detection signal Sf in synchronization with the predetermined time.

The instantaneous mileage calculator 62 calculates an instantaneous electric mileage (the electric mileage is referred to as a “mileage” in this specification) Ci [km/Ah] on the basis of the range ΔD [km] for every predetermined time and the amount of consumption ΔP [Ah] for every predetermined time.

The average mileage calculator 64 calculates an average of the instantaneous mileages Ci [km/Ah] to calculate an average mileage Cm [km/Ah].

The instantaneous possible range calculator 66 calculates a possible range (instantaneous possible range) Di [km] on the basis of the remaining amount of electricity R [Ah] and the instantaneous mileage Ci [km/Ah].

The current possible range calculator 68 calculates a possible range (current possible range) Dm [km] on the basis of the remaining amount of electricity R [km] and the average mileage Cm [km/Ah].

The instantaneous total range calculator 70 calculates a total range (instantaneous total range) Dit [km], which is the sum of the range D [km] from the last-time full charge and the instantaneous possible range Di [km].

The current total range calculator 72 calculates a total range (current total range) Dmt [km], which is the sum of the range D [km] from the last-time full charge and the current possible range Dm [km].

The storage processor 74 includes a storage part and stores the current total range Dmt [km] when the full charge has been detected as past total ranges Dpt [km] (including a last-time past total range Dpt1 [km] and a last-time-but-one past total range Dpt2 [km]).

The display unit 40 displays the past total ranges Dpt [km] (the last-time past total range Dpt1 [km] and the last-time-but-one past total range Dpt2 [km] in the present embodiment) and at least one of the current total range Dmt [km] and the instantaneous total range Dit [km] so as to enable the operator to compare the past total ranges Dpt [km] (the last-time past total range Dpt1 [km] and the last-time-but-one past total range Dpt2 [km]) with at least one of the current total range Dmt [km] involved in the current operation manner and the instantaneous total range Dit [km].

The range display apparatus 10 according to the present embodiment basically has the above configuration and basically operates in the above manner. A detailed operation of the range display apparatus 10 will be described below.

### First Embodiment

In a first embodiment of the present invention, the range display apparatus 10 has a function of displaying the current total range Dmt [km], the instantaneous total range Dit [km], and the past total ranges Dpt [km] in the display unit 40 so as to enable the operator to compare them with each other at a glance.

Upon insertion of the power-supply plug 34 connected to the battery ECU 24 into an outdoor outlet, which is a personal charge stand, or a public outlet, which is a public charge stand, the full-charge detector 54 detects the full charge by a known method of measuring the temperature of the battery 14, the voltage of the battery 14, etc. and supplies the full-charge amount of electricity Pfull [Ah] when the full charge of the battery 14 has been detected to the remaining-amount-of-electricity sensor 52, along with the full-charge detection signal Sf. Simultaneously with the supply of the full-charge amount of electricity Pfull [Ah] and the full-charge detection signal Sf to the remaining-amount-of-electricity sensor 52, the full-charge detection signal Sf is transmitted from the full-charge detector 54 to the range calculator 60 and the storage processor 74.

Practically, the full-charge detection signal Sf output from the full-charge detector 54 is supplied to the remaining-amount-of-electricity sensor 52 within the battery ECU 24 and is transmitted from the battery ECU 24 to the range calculator 60, etc. in the range ECU 36 through the communication line 44 (refer to FIG. 1). However, since the description with a transmission path that is specified makes the understanding of the embodiment of the present invention complicated, the transmission path, such as the communication line 44, is not referred to in the following description unless specifically required.

Upon reception of the full-charge detection signal Sf, the remaining-amount-of-electricity sensor 52 resets the remaining amount of electricity R [Ah] to a full-charge amount of electricity Rf [Ah] (R←Rf: meaning that the quantity on the left side of the arrow is replaced with the quantity on the right side thereof), and the range calculator 60 resets the range D from full charge (cumulative range) to zero (D←0). An operation of the storage processor 74 in response to reception of the full-charge detection signal Sf will be described below.

When the power-supply plug 34 is removed from the outlet and the electric vehicle 12 starts the travelling after the full charge, the vehicle-speed pulses Ps of a number corresponding to the number of revolutions of the axle 26 are successively supplied from the vehicle-speed pulse sensor 42 to the range calculator 60.

The range calculator 60 multiplies the number of vehicle-speed pulses Ps for every second (for every predetermined time) by a predetermined value taking consideration of the perimeter of tires to calculate the range ΔD [km] per second every second and supplies the calculated range ΔD [km] to the instantaneous mileage calculator 62. In addition, the range calculator 60 calculates the range D [km] from full charge since the full-charge detection signal Sf has been received according to Equation (1) and supplies the calculated range D [km] from full charge to the instantaneous total range calculator 70 and the current total range calculator 72:

D[km]=ΣΔD (1)

The cumulative calculation with Σ is performed every second (every predetermined time). The calculation of the range ΔD [km] n-number times results in the cumulative number of times of calculation that is equal to n.

The amount-of-consumption sensor 50 detects the current flowing through the battery 14 every second in synchronization with the calculation of the range ΔD [km] to calculate the amount of consumption ΔP [Ah] per second and supplies the calculated amount of consumption ΔP [Ah] to the instantaneous mileage calculator 62 and the remaining-amount-of-electricity sensor 52.

The instantaneous mileage calculator 62 calculates the instantaneous mileage Ci [km/Ah] on the basis of the amount of consumption ΔP [Ah] per second and the range ΔD [km] per second that are received according to Equation (2) and supplies the calculated instantaneous mileage Ci [km/Ah] to the average mileage calculator 64 and the instantaneous possible range calculator 66:

Ci[km/Ah]=ΔD/ΔP (2)

Specifically, the instantaneous mileage calculator 62 calculates the instantaneous mileage Ci [km/Ah] on the basis of the range ΔD [km] per second, which is an instantaneous value of the range D [km], and the amount of consumption ΔP [Ah] per second, which is an instantaneous value of an amount of consumption P.

The average mileage calculator 64 calculates the average mileage Cm [km/Ah] according to Equation (3) and supplies the calculated average mileage Cm [km/Ah] to the current possible range calculator 68:

Cm[km/Ah]=(1/n)ΣCi=(1/n)Σ(ΔD/ΔP) (3)

Specifically, the average mileage calculator 64 accumulates the instantaneous mileages Ci [km/Ah] n-number times and divides a cumulative value ΣCi by the cumulative number of times of calculation n to calculate the average mileage Cm [km/Ah] every second.

The average mileage Cm [km/Ah] calculated by the average mileage calculator 64 may be calculated according to Equation (4) on the basis of the range D=ΣΔD [km] from full charge, which is the range D [km] from the time when the average mileage calculator 64 has received the full-charge detection signal Sf from the full-charge detector 54 to the current time, and the amount of consumption P=ΣΔP [Ah] from full charge (calculated by the amount-of-consumption sensor 50), which is the amount of consumption P [Ah] from the time when the average mileage calculator 64 has received the full-charge detection signal Sf from the full-charge detector 54 to the current time, as illustrated by paths indicated by broken-lines with arrows in FIG. 3:

Cm[km/Ah]=D/P=ΣD/ΣP (4)

The remaining-amount-of-electricity sensor 52 subtracts the current amount of consumption ΔP [Ah] received from the amount-of-consumption sensor 50 from the last-time remaining amount of electricity R [Ah] (one second ago) to calculate the current remaining amount of electricity R [Ah] (R←R−ΔP) every second and supplies the calculated current remaining amount of electricity R [Ah] to the instantaneous possible range calculator 66 and the current possible range calculator 68.

The instantaneous possible range calculator 66 calculates the instantaneous possible range Di [km] every second according to Equation (5) on the basis of the instantaneous mileage Ci [km/Ah] calculated by the instantaneous mileage calculator 62 and the current remaining amount of electricity R [Ah] calculated by the remaining-amount-of-electricity sensor 52:

Di[km]=Ci×R (5)

The instantaneous total range calculator 70 calculates the instantaneous total range Dit [km] expressed by Equation (6) every second. The instantaneous total range Dit [km] is the sum of the range D from full charge calculated by the range calculator 60 and the instantaneous possible range Di calculated by the instantaneous possible range calculator 66:

Dit[km]=D+Di (6)

The current possible range calculator 68 calculates the current possible range Dm [km] every second according to Equation (7) on the basis of the average mileage Cm calculated by the average mileage calculator 64 and the current remaining amount of electricity R calculated by the remaining-amount-of-electricity sensor 52:

Dm[km]=Cm×R (7)

The current total range calculator 72 calculates the current total range Dmt expressed by Equation (8) every second. The current total range Dmt is the sum of the range D from full charge calculated by the range calculator 60 and the current possible range Dm calculated by the current possible range calculator 68:

Dmt[km]=D+Dm (8)

The storage processor 74 stores the current total range Dmt as the past total range Dpt upon reception of the full-charge detection signal Sf from the full-charge detector 54. Specifically, the last-time past total range Dpt is stored as Dpt1 (also referred to as a last-time total range Dpt1) and the last-time-but-one past total range Dpt is stored as Dpt2 (also referred to as a last-time-but-one total range Dpt2). Upon reception of the full-charge detection signal Sf, the last-time-but-one total range Dpt2 is stored as a past total range Dpt3 before the last-time-but-one past total range (also referred to as a total range Dpt3 before the last-time-but-one total range), the last-time total range Dpt1 is stored as the last-time-but-one total range Dpt2, and the last-time total range Dpt1 is newly stored.

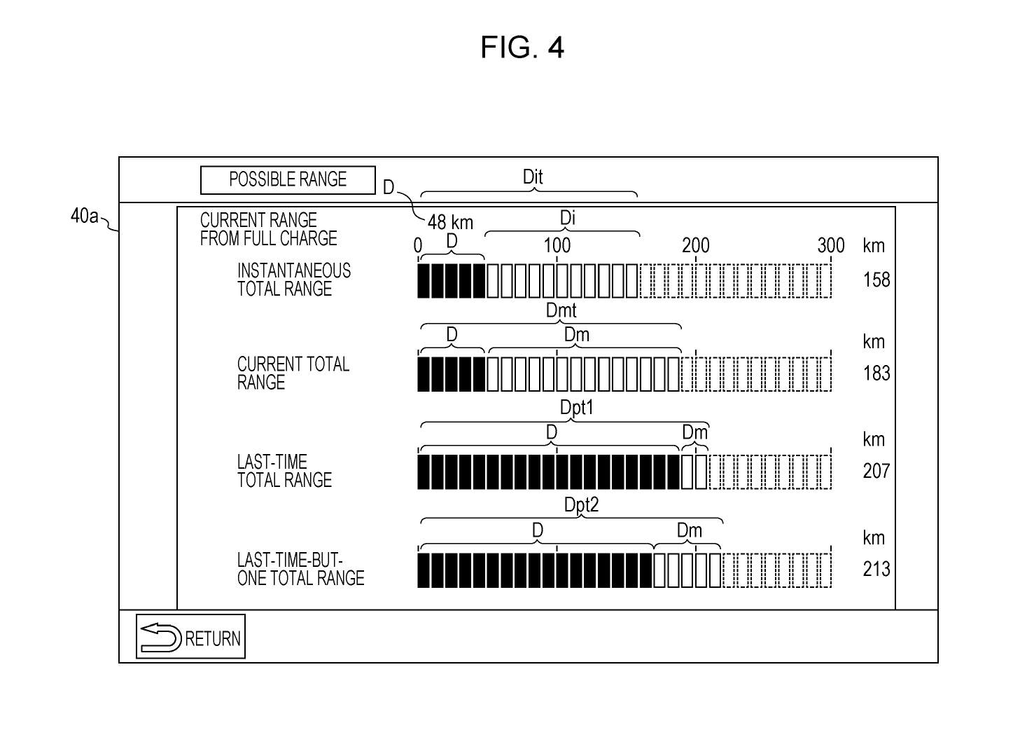

The display unit 40 arranges the instantaneous total range Dit, the current total range Dmt, the last-time total range Dpt1, and the last-time-but-one total range Dpt2 on a screen 40a in parallel for display so as to enable the operator to compare the instantaneous total range Dit, the current total range Dmt, the last-time total range Dpt1, and the last-time-but-one total range Dpt2 with each other, as illustrated in FIG. 4.

Specifically, the instantaneous total range Dit (Dit=158 [km]) is displayed by a bar having a length represented by horizontal arrangement of (resulting from addition of) the range D (D=48 [km]) which the electric vehicle has actually travelled since the full charge and which is represented by horizontal arrangement of filled rectangular blocks each corresponding to a range unit of 10 km (a predetermined distance unit) and the instantaneous possible range Di (Di=110 [km]) per second, which is represented by horizontal arrangement of non-filled solid-line rectangular blocks each corresponding to a range unit of 10 km (the predetermined distance unit) (a first display bar). Rectangles drawn by broken lines each represent a distance unit of 10 km (the predetermined distance unit) which the electric vehicle does not travel, and the bar has a length of 300 [km] (0 to 300 (0, 100, 200, and 300) [km]) at full scale.

The screen 40a of the display unit 40 is a liquid crystal display screen in the present embodiment. In a practical display mode, the filled rectangular blocks are displayed brightly in yellow, the non-filled solid-line rectangular blocks are displayed brightly in white, and the broken-line rectangles are transparently displayed. The rectangular blocks have a background color of ultramarine. Characters are displayed in white or yellow.

The current total range Dmt (Dmt=183 [km]) is displayed by a bar having a length represented by horizontal arrangement of (resulting from addition of) the range D (D=48 [km]) which the electric vehicle has actually travelled since the full charge and which is represented by horizontal arrangement of filled rectangular blocks each corresponding to a range unit of 10 km and the current possible range Dm (Dm=135 [km]) per second, which is represented by horizontal arrangement of non-filled solid-line rectangular blocks each corresponding to a range unit of 10 km (a second display bar).

The last-time total range Dpt1 (Dpt1=207 [km]) is displayed by a bar having a length represented by horizontal arrangement of (resulting from addition of) the range D (180 [km]<D<190 [km]) from the last-time-but-one full charge to the last-time full charge and the possible range Dm (20 [km]<Dm<30 [km]) immediately before the last-time full charge (a third display bar).

The last-time-but-one total range Dpt2 (Dpt2=213 [km]) is displayed by a bar having a length represented by horizontal arrangement of (resulting from addition of) the range D (160 [km]<D<170 [km]) from the full charge before the last-time-but-one full charge to the last-time-but-one full charge and the possible range Dm (50 [km]<Dm<60 [km]) immediately before the last-time-but-one full charge.

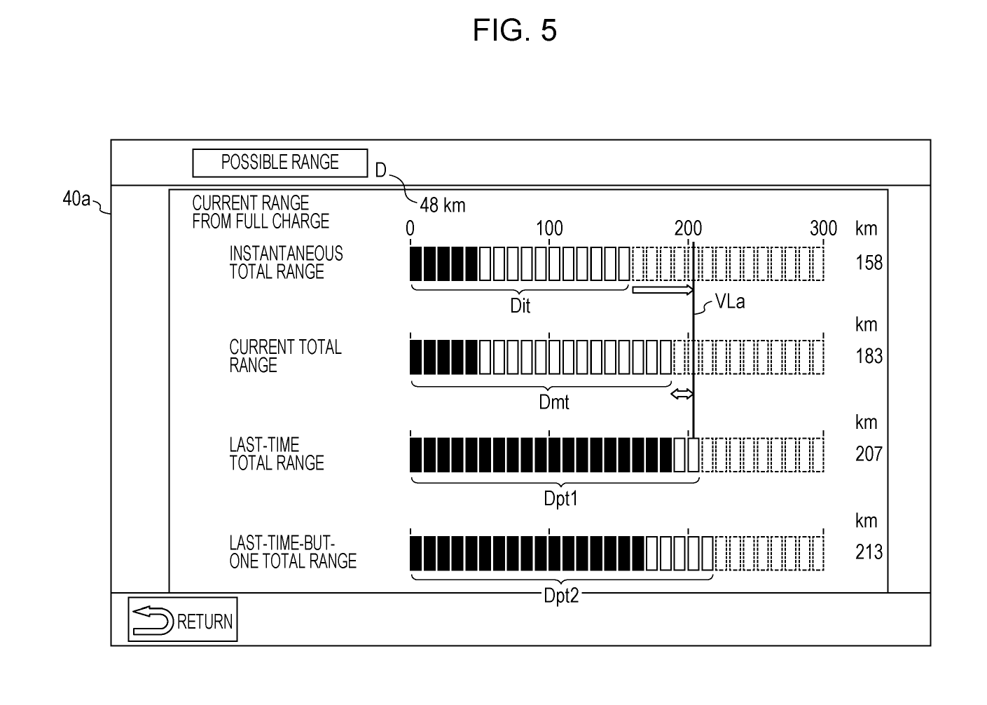

FIG. 5 illustrates the screen 40a in FIG. 4 again (part of the description in the screen 40a in FIG. 4 is omitted in FIG. 5). The operator of the electric vehicle finds from the screen 40a of the display unit 40 in FIG. 5 that continuation of the current operation state and manner determined from the instantaneous total range Dit decreases (is decreasing) the current total range Dmt because the display bar of the instantaneous total range Dit=158 [km] is shorter than the display bar of the current total range Dmt=183 [km]. Conversely, the operator of the electric vehicle finds that driving of the electric vehicle so as to make the display bar of the instantaneous total range Dit [km] longer than the display bar of the current total range Dmt [km] increases (is increasing) the current total range Dmt with the current operation state and manner.

The operator of the electric vehicle also finds from the screen 40a of the display unit 40 in FIG. 5 whether the total range Dmt at the current full charge is made longer than the total range Dpt1 at the last-time full charge by comparison in length between the display bar of the current total range Dmt=183 [km] and the display bar of the last-time total range Dpt1=207 [km]. A vertical line VLa in FIG. 5 indicates the value (207 [km]) of the last-time total range Dpt1. In the example in FIG. 5, since Dmt<Dpt1 (the current total range<the last-time total range), the operator can recognize that the operation from the current full charge decreases the range, compared with the operation from the last-time full charge.

Accordingly, as described above, the operator preferably drives the electric vehicle so that the instantaneous total range Dit is made longer than the last-time total range Dpt1 (Dit>Dpt1) to attempt to make the current total range Dmt that is longer than the last-time total range Dpt1 (Dmt>Dpt1). In other words, the guideline for the current operation is clarified.

The operator of the electric vehicle 12 the range of which is shorter than that of a typical engine vehicle is capable of finding how long the possible range, the instantaneous possible range Di in this case, is capable of being increased with the current driving state (for example, the operation or non-operation state of a heater or an air conditioner) and the current operation manner (for example, acceleration work in which speed control is performed by depression of a pedal).

Although the comparison of the mileages cannot be performed with the range from full charge to the next full charge in related art, it is possible to compare the mileages with the ranges according to the present embodiment. On the screen 40a in FIG. 4, the last-time-but-one mileage is higher than the last-time mileage because the last-time-but-one range D is shorter than the last-time range D but, as for the past total ranges Dpt, the last-time total range Dpt1=207 [km] is shorter than the last-time-but-one total range Dpt2=213 [km].

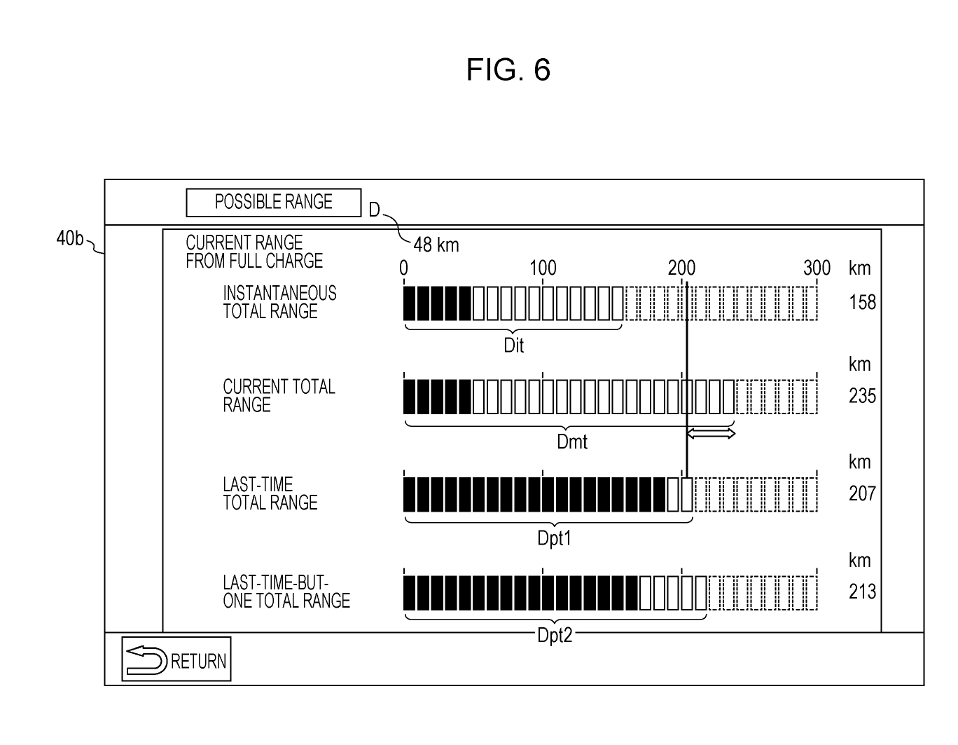

FIG. 6 illustrates a specific example concerning another operation state and manner, displayed on a screen 40b of the display unit 40.

A case in which the current total range Dmt=235 [km] is longer than the last-time total range Dpt1=207 [km] (Dpt1<Dmt) is illustrated on the screen 40b.

For example, when the electric vehicle 12 is caught in a traffic jam or an air conditioner that has been turned off is turned on, the instantaneous total range Dit=158 [km] becomes shorter than the current total range Dmt=235 [km]. Accordingly, continuation of the current operation state gradually decreases the current total range Dmt=235 [km] to be close to the last-time total range Dpt1=207 [km]. Since the instantaneous total range Dit=158 [km] is shorter than the last-time total range Dpt1=207 [km], the operation state and manner from the current full charge to the current time is economical but the good state will not continue. The operator knows that the current total range Dmt will become shorter than the last-time total range Dpt1.

In other words, when the current total range Dmt=235 [km] is longer than the last-time total range Dpt1=207 [km] (Dpt1<Dmt), the current operation state and manner causes the range to be longer than that in the last-time operation state and manner. However, since the instantaneous total range Dit=158 [km] is shorter than the last-time total range Dpt1=207 [km], the operator knows that continuation of the driving at the current instantaneous total range Dit=158 [km] finally causes the total range to be shorter than the last-time total range Dpt1=207 [km]. Accordingly, the operator knows that the operator preferably attempts the driving causing the instantaneous total range Dit=158 [km] to increase so as to keep the current total range Dmt=235 [km].

As described above, in the first embodiment described above, the range calculator 60 calculates the range D=ΣΔD [km] from full charge of the battery 14. The amount-of-consumption sensor 50 (an amount-of-consumption calculator) calculates the amount of consumption ΣΔP [Ah] from full charge, which is the amount of consumption of the battery 14 from the time when the full charge has been detected to the current time. The remaining-amount-of-electricity sensor 52 (a remaining-amount-of-electricity calculator) subtracts the amount of consumption ΣΔP [Ah] from the amount of electricity at full charge to calculate the remaining amount of electricity R of the battery 14. The full-charge detector 54 detects the full charge of the battery 14.

The average mileage calculator 64 calculates the average mileage Cm [km/Ah]=D/P=ΣΔD/ΣΔP on the basis of the range D=ΣΔD [km] from full charge, which is the range from the time when the full-charge detector 54 has detected the full charge to the current time, and the amount of consumption P=ΣΔP [Ah] from full charge, which is the amount of consumption from the time when the full-charge detector 54 has detected the full charge to the current time.

The instantaneous mileage calculator 62 calculates the instantaneous mileage Ci [km/Ah]=ΔD/ΔP on the basis of the range ΔD per second, which is an instantaneous value of the range, and the amount of consumption ΔP [Ah] per second, which is an instantaneous value of the amount of consumption of the battery 14. The current possible range calculator 68 calculates the current possible range Dm [km]=Cm×R on the basis of the average mileage Cm [km/Ah] and the remaining amount of electricity R [Ah] of the battery 14. The instantaneous possible range calculator 66 calculates the instantaneous possible range Di [km]=Ci×R on the basis of the calculated instantaneous mileage Ci and the remaining amount of electricity R [Ah] of the battery 14.

The current total range calculator 72 calculates the current total range Dmt [km]=ΣΔD+Dm, which is the sum of the current possible range Dm [km] and the range ΣΔD from full charge of the battery 14. The instantaneous total range calculator 70 calculates the instantaneous total range Dit [km]=ΣΔD+Di, which is the sum of the range ΣΔD from full charge of the battery 14 and the instantaneous possible range Di [km].

The storage processor 74 stores the current total range Dmt [km] when the full-charge detector 54 has detected the full charge as the past total ranges Dpt ( . . . , the last-time-but-one total range Dpt2, and the last-time total range Dpt1).

The display unit 40 displays the current total range Dmt, which is the sum of the range ΣΔD from full charge and the current possible range Dm, the instantaneous total range Dit, which is the sum of the instantaneous possible range Di calculated on the basis of the instantaneous mileage Ci and the remaining amount of electricity R of the battery 14 and the range D=ΣΔD from full charge, and the past total ranges Dpt, which is the current total range calculated when the full charge has been detected, on the screen 40a or 40b so as to enable the operator to compare the current total range Dmt, the instantaneous total range Dit, and the past total ranges Dpt with each other.

According to the first embodiment, it is possible for the operator to know at a glance how long the possible range (the instantaneous total range Dit or the current total range Dmt) is capable of being increased, compared with the past total ranges Dpt, with the current operation state and manner. Accordingly, it is possible to clarify the guideline for the current driving target.

### First Modification of First Embodiment

In a first modification of the first embodiment, the range display apparatus 10 has a function of displaying the instantaneous total range Dit [km] and the past total ranges Dpt [km] in the display unit 40 so as to enable the operator to compare the instantaneous total range Dit [km] with the past total ranges Dpt [km] at a glance.

The configuration in the first modification differs from that in the first embodiment only in the content of display involved in the configuration of the display unit 40.

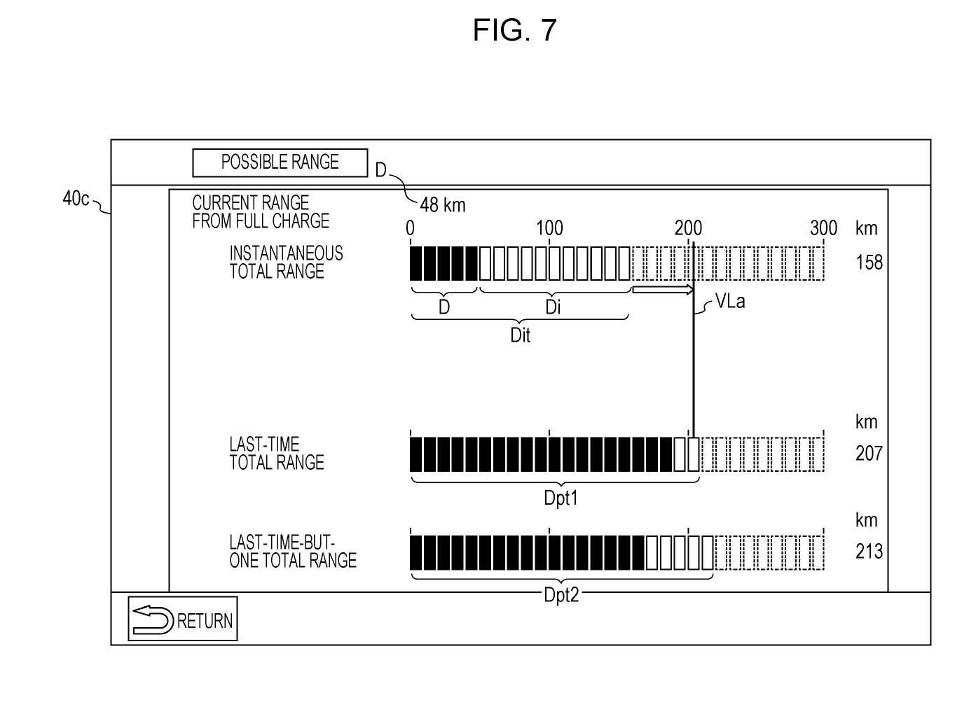

Specifically, as illustrated in a display example of the first modification in FIG. 7, the display unit 40 displays a screen 40C in which the instantaneous total range Dit, which is the sum of the range D=ΣΔD from full charge of the battery 14 and the instantaneous possible range Di calculated on the basis of the instantaneous mileage Ci and the remaining amount of electricity R of the battery 14, and the past total ranges Dpt (the last-time total range Dpt1 and the last-time-but-one total range Dpt2), which are the current total ranges calculated when the full charge has been detected, are arranged in parallel for display so as to enable the operator to compare the instantaneous total range Dit with the past total ranges Dpt.

Since the past total ranges Dpt (the last-time total range Dpt1 and the last-time-but-one total range Dpt2) and the instantaneous total range Dit are displayed on the screen 40C of the display unit 40 so as to enable the operator to compare the past total ranges Dpt with the instantaneous total range Dit in the above manner, it is possible for the operator to know how long the possible range is capable of being increased with the current operation state and manner. Accordingly, it is possible to clarify the guideline for the current driving target.

### Second Modification of First Embodiment

In a second modification of the first embodiment, the range display apparatus 10 has a function of displaying the current total range Dmt [km] and the past total ranges Dpt [km] in the display unit 40 so as to enable the operator to compare the current total range Dmt [km] with the past total ranges Dpt [km] at a glance.

The configuration involved in the calculation for the display of the instantaneous total range Dit is deleted from the configuration in the first embodiment in the second modification.

Specifically, the range calculator 60 calculates the range D=ΣΔD [km] from full charge of the battery 14. The amount-of-consumption sensor 50 (the amount-of-consumption calculator) calculates the amount of consumption P=ΣΔP [Ah] from full charge, which is the amount of consumption of the battery 14 from the time when the full charge has been detected to the current time. The remaining-amount-of-electricity sensor 52 (the remaining-amount-of-electricity calculator) subtracts the amount of consumption P=ΣΔP [Ah] from the amount of electricity Pfull [Ah] at full charge to calculate the remaining amount of electricity R (R=Pfull-P) of the battery 14. The full-charge detector 54 detects the full charge of the battery 14.

The average mileage calculator 64 calculates the average mileage Cm [km/Ah]=D/P=ΣΔD/ΣΔP on the basis of the range D [km]=ΣΔD from full charge, which the range from the time when the full-charge detector 54 has detected the full charge to the current time, and the amount of consumption P [Ah]=ΣΔP from full charge, which is the amount of consumption from the time when the full-charge detector 54 has detected the full charge to the current time.

The current possible range calculator 68 calculates the current possible range Dm=Cm×R [km] on the basis of the average mileage Cm [km/Ah] and the remaining amount of electricity R [Ah] of the battery 14.

The current total range calculator 72 calculates the current total range Dmt [km]=D+Dm=ΣΔD+Dm, which is the sum of the current possible range Dm [km] and the range D=ΣΔD from full charge of the battery 14.

The storage processor 74 stores the current total range Dmt [km] when the full-charge detector 54 has detected the full charge as the past total ranges Dpt ( . . . , the last-time-but-one total range Dpt2, and the last-time total range Dpt1).

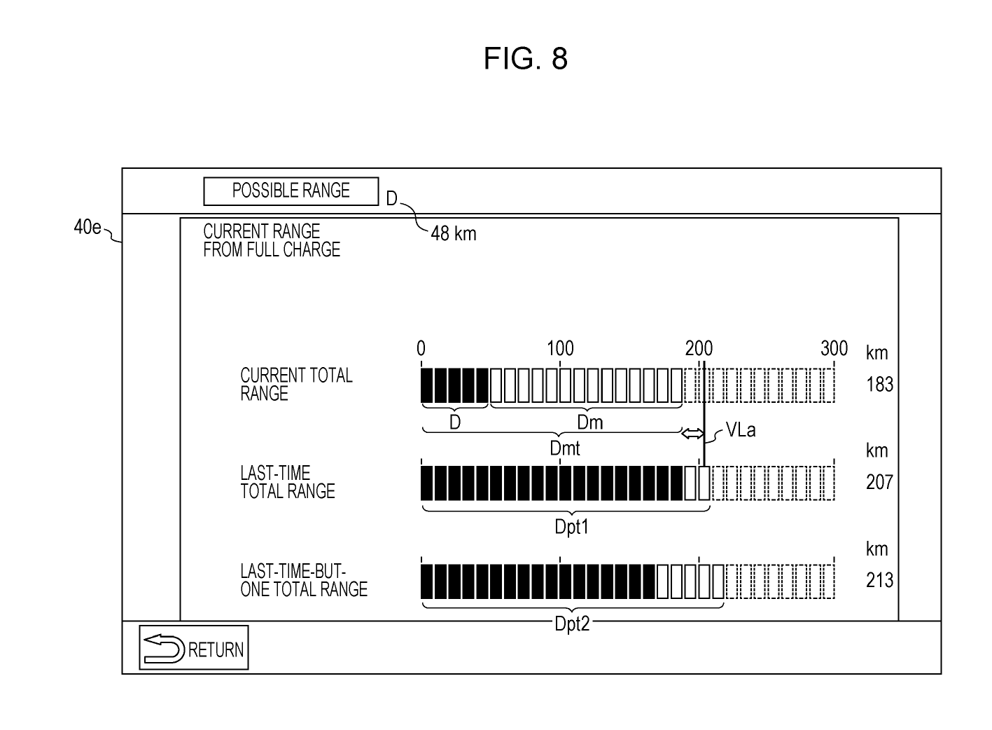

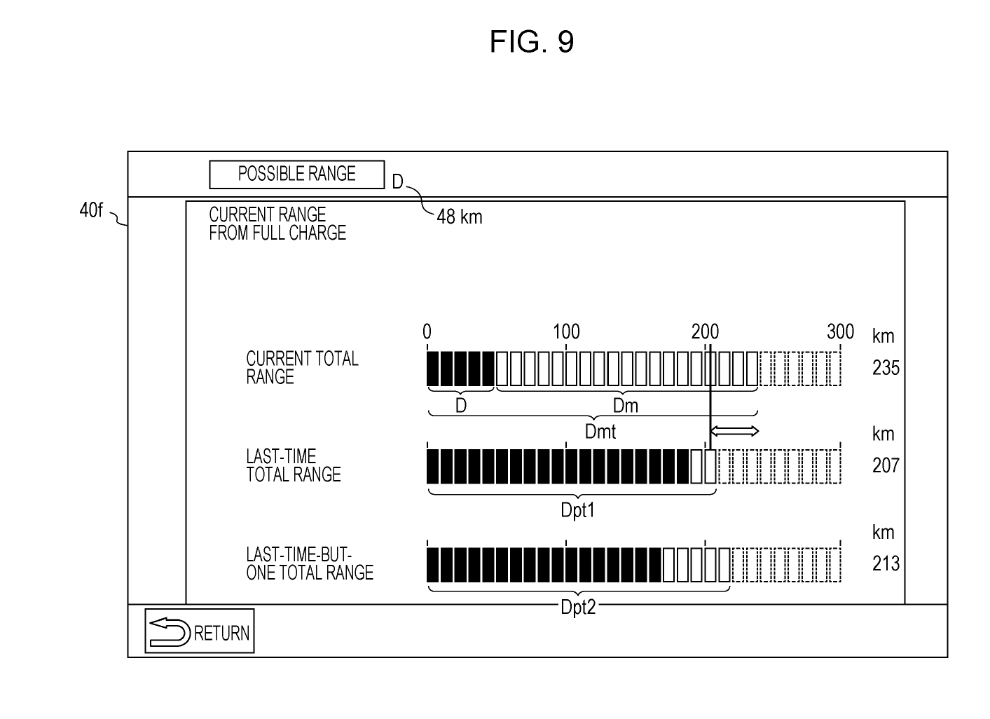

The display unit 40 displays the current total range Dmt, which is the sum of the range D=ΣΔD from full charge and the current possible range Dm, and the past total ranges Dpt (Dpt1 and Dpt2), which are the current total ranges calculated when the full charge has been detected, on screens 40e and 40f, as illustrated in FIG. 8 and FIG. 9, respectively, so as to enable the operator to compare the current total range Dmt with the past total ranges Dpt.

According to the second modification, since it is possible for the operator to know how long the current total range Dmt is increased (the screen 40f in FIG. 9) or is not increased (the screen 40e in FIG. 8), compared with the past total ranges Dpt, with the current operation state and manner at a glance. Accordingly, it is possible to clarify the guideline for the current driving target.

### Second Embodiment

In a second embodiment of the present invention, highlighting is performed, for example, the color of a display bar is varied, if the instantaneous possible range Di or the current possible range Dm is shorter than the remaining distance to a destination that is set to enable the operator to easily recognize that it is not possible for the electric vehicle to reach the destination with the past operation manner.

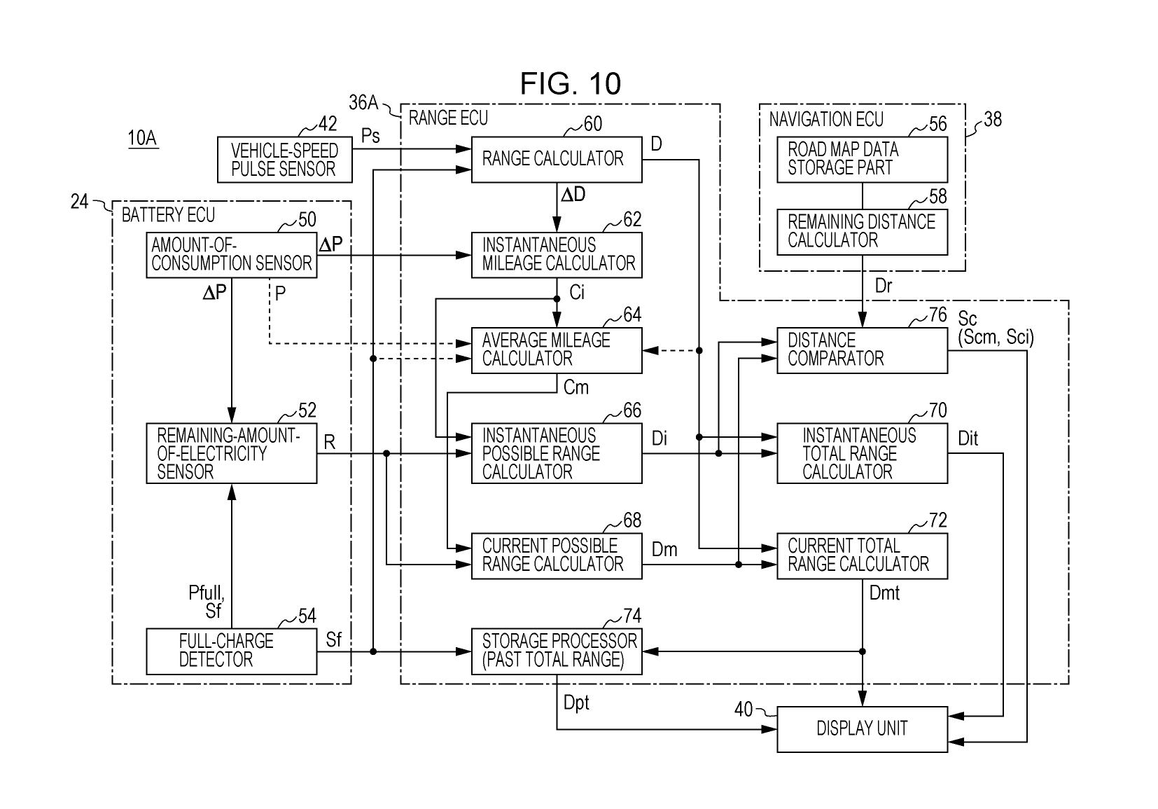

FIG. 10 is a block diagram illustrating an example of the configuration of a range display apparatus 10A according to the second embodiment. The range display apparatus 10A includes the navigation ECU 38, in addition to the vehicle-speed pulse sensor 42 provided in the motor 20, the battery ECU 24, a range ECU 36A additionally including a distance comparator 76, and the display unit 40. The navigation ECU 38 and the display unit 40 may integrally compose a navigation apparatus by commonly using the display unit or the display unit 40 may be separated from the navigation apparatus as a range indicator.

The navigation ECU 38 includes a road map data storage part 56 and a remaining distance calculator 58. The remaining distance calculator 58 calculates a remaining distance Dr [km] from a current position to a destination by referring to road map data stored in the road map data storage part 56. The destination is set with an input device (not shown), for example, a keyboard including a touch panel, and the current position is detected by a current-position detecting part (not shown) (for example, a Global Positioning System (GPS) positioning part).

The distance comparator 76 compares the instantaneous possible range Di [km] with the remaining distance Dr [km] or compares the current possible range Dm [km] with the remaining distance Dr [km] to output a result Sc of comparison (data about the result of the comparison).

The display unit 40 highlights the current possible range Dm [km] or the instantaneous possible range Di [km] shorter than the remaining distance Dr in the display of the range in accordance with a result Scm of comparison between the current possible range Dm [km] and the remaining distance Dr in the distance comparator 76 and a result Sci of comparison between the instantaneous possible range Di [km] and the remaining distance Dr [km] in the distance comparator 76.

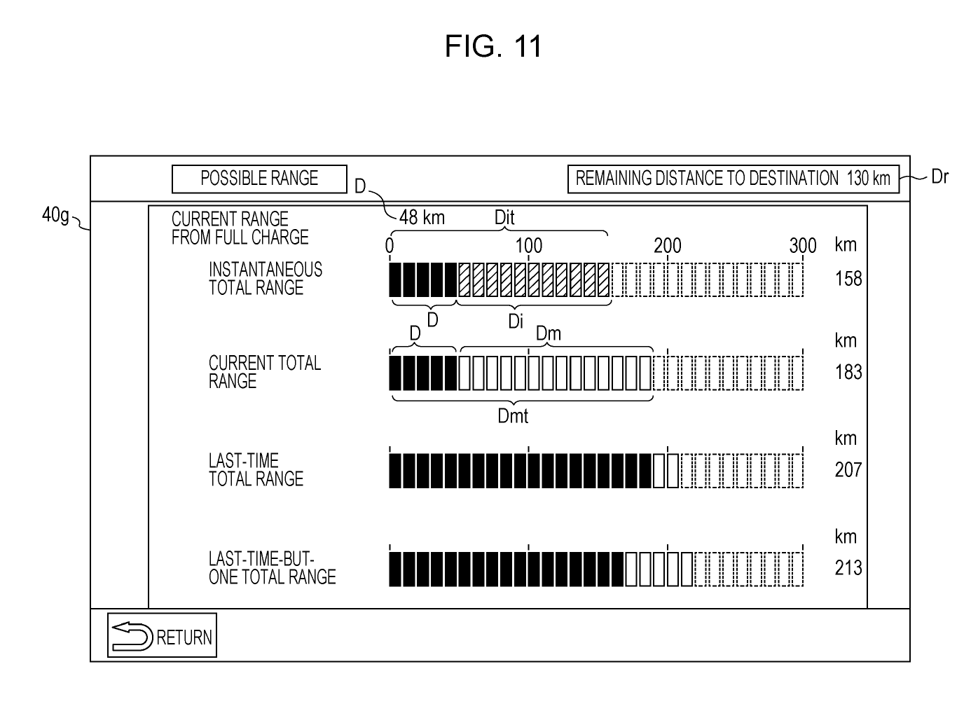

FIG. 11 illustrates a specific example of the highlighting, displayed on a screen 40g of the display unit 40. Since the current possible range Dm [km]=Dmt−D=183 [km]−48 [km]=135 [km] is longer than the remaining distance Dr=130 [km] to the destination, the electric vehicle reaches the destination.

However, the instantaneous possible range Di [km]=Dit−D=158 [km]−48 [km]=110 [km] is shorter than the remaining distance Dr=130 [km]. Accordingly, the electric vehicle does not possibly reach the destination by continuation of the current operation manner.

As a countermeasure against the above state, rectangular blocks composing the bar of the instantaneous possible range Di is display in red (is hatched in FIG. 11) for highlighting to enable the operator to easily recognize that the electric vehicle does not possibly reach the destination by continuation of the current operation state and manner.

According to the second embodiment, the current possible range Dm or the instantaneous possible range Di is highlighted if the electric vehicle is not capable of reaching the destination by continuation of the current operation state and manner, that is, if the current possible range Dm or the instantaneous possible range Di is shorter than the remaining distance Dr to the destination, which is a target range. Accordingly, the operator can instantaneously know whether the electric vehicle is capable of reaching the destination, that is, whether the electric vehicle is capable of covering the remaining distance 130 [km], which is a target range, by continuation of the current operation state and manner.

The present invention is not limited to the above embodiments. For example, the past total ranges Dpt are not limited to the last-time total range and the last-time-but-one total range and may be displayed as a past maximum value in the display examples in FIG. 4, FIG. 5, FIG. 6, FIG. 7, FIG. 8, FIG. 9, and FIG. 11 on the basis of the content of this specification. For example, the last-time-but-one total range Dpt2 may be replaced with a past maximum value (a value providing the longest range) to arrange the last-time total range Dpt1 and the maximum value in the past total ranges in parallel for display.

According to an embodiment of the present invention, a range display apparatus includes a range calculating unit configured to calculate a range; an amount-of-consumption calculating unit configured to calculate an amount of consumption of a battery; a remaining-amount-of-electricity calculating unit configured to calculate a remaining amount of electricity of the battery; a full-charge detecting unit configured to detect full charge of the battery; an average mileage calculating unit configured to calculate an average mileage on the basis of a range from full charge, which is the range from a time when the full-charge detecting unit has detected the full charge to a current time, and an amount of consumption from full charge, which is the amount of consumption from the time when the full-charge detecting unit has detected the full charge to the current time; an instantaneous mileage calculating unit configured to calculate an instantaneous mileage on the basis of an instantaneous value of the range and an instantaneous value of the amount of consumption; a current possible range calculating unit configured to calculate a current possible range on the basis of the average mileage and the remaining amount of electricity; an instantaneous possible range calculating unit configured to calculate an instantaneous possible range on the basis of the instantaneous mileage and the remaining amount of electricity; a current total range calculating unit configured to calculate a current total range, which is a sum of the range from full charge and the current possible range; an instantaneous total range calculating unit configured to calculate an instantaneous total range, which is a sum of the range from full charge and the instantaneous possible range; a storage unit configured to store the current total range calculated when the full-charge detecting unit has detected the full charge as a past total range; and a display unit configured to display the current total range, the instantaneous total range, and the past total range such that the current total range, the instantaneous total range, and the past total range are capable of being compared with each other.

The range display apparatus according to the above embodiment calculates the average mileage on the basis of the range from full charge of the battery and the amount of consumption from full charge of the battery, which is the amount of consumption of the battery from the time when the full charge has been detected to the current time, and calculates the current possible range on the basis of the calculated average mileage and the remaining amount of electricity of the battery. In addition, the range display apparatus calculates the current total range, which is the sum of the calculated current possible range and the range from full charge of the battery. Furthermore, the range display apparatus calculates the instantaneous mileage on the basis of an instantaneous value of the range and an instantaneous value of the amount of consumption of the battery, calculates the instantaneous possible range on the basis of the calculated instantaneous mileage and the remaining amount of electricity of the battery, and calculates the instantaneous total range, which is the sum of the calculated instantaneous possible range and the range from full charge of the battery.

Furthermore, since the range display apparatus displays the current total range, which is the sum of the range from full charge and the current possible range, the instantaneous total range, which is the sum of the instantaneous possible range calculated on the basis of the instantaneous mileage and the remaining amount of electricity of the battery and the range from full charge, and the past total range, which is the current total range calculated when the full charge has been detected, in the display unit such that the current total range, and the instantaneous total range, and the past total range are capable of being compared with each other, it is possible for a user, such as the operator, to know how long the possible range is capable of being increased with the current operation state and manner. Accordingly, it is possible for the user to clarify the guideline for the current operation target by comparing the range involved in the past operation state with the range involved in the current operation state.

According to another embodiment of the present invention, a range display apparatus includes a range calculating unit configured to calculate a range; an amount-of-consumption calculating unit configured to calculate an amount of consumption of a battery; a remaining-amount-of-electricity calculating unit configured to calculate a remaining amount of electricity of the battery; a full-charge detecting unit configured to detect full charge of the battery; an average mileage calculating unit configured to calculate an average mileage on the basis of a range from full charge, which is the range from a time when the full-charge detecting unit has detected the full charge to a current time, and an amount of consumption from full charge, which is the amount of consumption from the time when the full-charge detecting unit has detected the full charge to the current time; a current possible range calculating unit configured to calculate a current possible range on the basis of the average mileage and the remaining amount of electricity; a current total range calculating unit configured to calculate a current total range, which is a sum of the range from full charge and the current possible range; a storage unit configured to store the current total range calculated when the full-charge detecting unit has detected the full charge as a past total range; and a display unit configured to display the current total range and the past total range such that the current total range and the past total range are capable of being compared with each other.

The range display apparatus according to the above embodiment calculates the average mileage on the basis of the range from full charge of the battery and the amount of consumption from full charge, which is the amount of consumption of the battery from the time when the full charge has been detected to the current time, and calculates the current possible range on the basis of the calculated average mileage and the remaining amount of electricity of the battery. In addition, since the range display apparatus displays the current total range, which is the sum of the calculated current possible range and the range from full charge of the battery, and the past total range, which is the current total range calculated when the full charge has been detected, in the display unit such that the current total range and the past total range are capable of being compared with each other, it is possible for the user, such as the operator, to know how long the possible range is capable of being increased with the current operation state and the current operation manner. Also in this case, it is possible for the user to clarify the guideline for the current operation target by comparing the range involved in the past operation state with the range involved in the current operation state.

According to another embodiment of the present invention, a range display apparatus includes a range calculating unit configured to calculate a range; an amount-of-consumption calculating unit configured to calculate an amount of consumption of a battery; a remaining-amount-of-electricity calculating unit configured to calculate a remaining amount of electricity of the battery; a full-charge detecting unit configured to detect full charge of the battery; an average mileage calculating unit configured to calculate an average mileage on the basis of a range from full charge, which is the range from a time when the full-charge detecting unit has detected the full charge to a current time, and an amount of consumption from full charge, which is the amount of consumption from the time when the full-charge detecting unit has detected the full charge to the current time; an instantaneous mileage calculating unit configured to calculate an instantaneous mileage on the basis of an instantaneous value of the range and an instantaneous value of the amount of consumption; a current possible range calculating unit configured to calculate a current possible range on the basis of the average mileage and the remaining amount of electricity; an instantaneous possible range calculating unit configured to calculate an instantaneous possible range on the basis of the instantaneous mileage and the remaining amount of electricity; a current total range calculating unit configured to calculate a current total range, which is a sum of the range from full charge and the current possible range; an instantaneous total range calculating unit configured to calculate an instantaneous total range, which is a sum of the range from full charge and the instantaneous possible range; a storage unit configured to store the current total range calculated when the full-charge detecting unit has detected the full charge as a past total range; and a display unit configured to display the instantaneous total range and the past total range such that the instantaneous total range and the past total range are capable of being compared with each other.

The range display apparatus according to the above embodiment calculates the instantaneous mileage on the basis of an instantaneous value of the range and an instantaneous value of the amount of consumption of the battery, calculates the instantaneous possible range on the basis of the calculated instantaneous mileage and the remaining amount of electricity of the battery, and calculates the instantaneous total range, which is the sum of the calculated instantaneous possible range and the range from full charge of the battery. In addition, the range display apparatus calculates the average mileage on the basis of the range from full charge of the battery and the amount of consumption from full charge, which is the amount of consumption of the battery from the time when the full charge has been detected to the current time, calculates the current possible range on the basis of the calculated average mileage and the remaining amount of electricity of the battery, and calculates the current total range, which is the sum of the calculated current possible range and the range from full charge of the battery.

Furthermore, since the range display apparatus displays the past total range, which is the current total range calculated when the full charge has been detected, and the instantaneous total range, which is the sum of the instantaneous possible range calculated on the basis of the instantaneous mileage and the remaining amount of electricity of the battery and the range from full charge of the battery, in the display unit such that the past total range and the instantaneous total range are capable of being compared with each other, it is possible for the user, such as the operator, to know how long the possible range is capable of being increased with the current operation state and manner. Also in this case, it is possible for the user to clarify the guideline for the current operation target by comparing the range involved in the past operation state with the range involved in the current operation state.

The range display apparatus may further include a remaining distance calculating unit configured to calculate a remaining distance to a destination; and a distance comparing unit configured to compare the current possible range or the instantaneous possible range with the remaining distance. The display unit may highlight the current possible range or the instantaneous possible range if the current possible range or the instantaneous possible range is shorter than the remaining distance.

Since the range display apparatus highlights the current possible range or the instantaneous possible range if the electric vehicle is not capable of covering the remaining distance to a destination, which is a target range, by continuation of the current operation manner, that is, if the current possible range or the instantaneous possible range is shorter than the remaining distance, it is possible for the user to instantaneously know whether the electric vehicle is capable of covering the target range by continuation of the current operation state and manner.

In the range display apparatus, it is preferred that the display unit display the instantaneous total range as a first display bar resulting from addition of a display bar corresponding to the range from full charge to a display bar corresponding to the instantaneous possible range, display the current total range as a second display bar resulting from addition of a display bar corresponding to the range from full charge to a display bar corresponding to the current possible range, display the past total range as a third display bar, and arrange the first to third display bars in parallel on a screen for display. In this case, it is possible for the user to compare the instantaneous total range, the current total range, and the past total range with each other at a glance. Accordingly, it is possible for the user to clarify the guideline for the current operation target.

The embodiment of the present invention is also applicable to an electric vehicle having the range display apparatus mounted therein. The electric vehicle includes a plug-in hybrid vehicle.

According to the embodiment of the present invention, since the range display apparatus displays the past total range and at least one of the current total range involved in the current operation manner and the instantaneous total range so as to enable the operator to compare the past total range with at least one of the current total range and the instantaneous total range, it is possible for the user to know how long the possible range is capable of being increased with the current operation state and the current operation manner (the current operation state and manner).

The user, such as the operator, can clarify the guideline for the current operation target by comparing the range involved in the past operation state with the range involved in the current operation state.

Obviously, numerous modifications and variations of the present invention are possible in light of the above teachings. It is therefore to be understood that within the scope of the appended claims, the invention may be practiced otherwise than as specifically described herein.

What is claimed is:

1. A range display apparatus comprising:
a range calculator configured to calculate a range;
an amount-of-consumption calculator configured to calculate an amount of consumption of a battery;
a remaining-amount-of-electricity calculator configured to calculate a remaining amount of electricity of the battery;
a full-charge detector configured to detect full charge of the battery;
an average mileage calculator configured to calculate an average mileage based on a first range from full charge and a first amount of consumption from full charge, the first range being a range from a time when the full-charge detector has detected the full charge to a current time, the first amount of consumption being an amount of consumption from a time when the full-charge detector has detected the full charge to the current time;
an instantaneous mileage calculator configured to calculate an instantaneous mileage based on an instantaneous value of the range calculated by the range calculator and an instantaneous value of the amount of consumption calculated by the amount-of-consumption calculator;
a current possible range calculator configured to calculate a current possible range based on the average mileage calculated by the average mileage calculator and the remaining amount of electricity calculated by the remaining-amount-of-electricity calculator;
an instantaneous possible range calculator configured to calculate an instantaneous possible range based on the instantaneous mileage calculated by the instantaneous mileage calculator and the remaining amount of electricity;
a current total range calculator configured to calculate a current total range, the current total range being a sum of the first range and the current possible range;
an instantaneous total range calculator configured to calculate an instantaneous total range, the instantaneous total range being a sum of the first range and the instantaneous possible range;
a storage device configured to store the current total range calculated by the current total range calculator when the full-charge detector has detected the full charge as a past total range; and
a display configured to display the current total range, the instantaneous total range, and the past total range such that the current total range, the instantaneous total range, and the past total range are compared with each other.

2. A range display apparatus comprising:
a range calculator configured to calculate a range;
an amount-of-consumption calculator configured to calculate an amount of consumption of a battery;
a remaining-amount-of-electricity calculator configured to calculate a remaining amount of electricity of the battery;
a full-charge detector configured to detect full charge of the battery;
an average mileage calculator configured to calculate an average mileage based on a first range from full charge and a first amount of consumption from full charge, the first range being a range from a time when the full-charge detector has detected the full charge to a current time, the first amount of consumption being an amount of consumption from a time when the full-charge detector has detected the full charge to the current time;
a current possible range calculator configured to calculate a current possible range based on the average mileage calculated by the average mileage calculator and the remaining amount of electricity calculated by the remaining-amount-of-electricity calculator;
a current total range calculator configured to calculate a current total range, the current total range being a sum of the first range and the current possible range;
a storage device configured to store the current total range calculated by the current total range calculator when the full-charge detector has detected the full charge as a past total range; and
a display configured to display the current total range and the past total range such that the current total range and the past total range are compared with each other.

3. A range display apparatus comprising:
a range calculator configured to calculate a range;
an amount-of-consumption calculator configured to calculate an amount of consumption of a battery;
a remaining-amount-of-electricity calculator configured to calculate a remaining amount of electricity of the battery;
a full-charge detector configured to detect full charge of the battery;
an average mileage calculator configured to calculate an average mileage based on a first range from full charge and a first amount of consumption from full charge, the first range being a range from a time when the full-charge detector has detected the full charge to a current time, the first amount of consumption being an amount of consumption from a time when the full-charge detector has detected the full charge to the current time;
an instantaneous mileage calculator configured to calculate an instantaneous mileage based on an instantaneous value of the range calculated by the range calculator and an instantaneous value of the amount of consumption calculated by the amount-of-consumption calculator;
a current possible range calculator configured to calculate a current possible range based on the average mileage calculated by the average mileage calculator and the remaining amount of electricity calculated by the remaining-amount-of-electricity calculator;
an instantaneous possible range calculator configured to calculate an instantaneous possible range based on the instantaneous mileage calculated by the instantaneous mileage calculator and the remaining amount of electricity;
a current total range calculator configured to calculate a current total range, the current total range being a sum of the first range and the current possible range;
an instantaneous total range calculator configured to calculate an instantaneous total range, the instantaneous total range being a sum of the first range and the instantaneous possible range;
a storage device configured to store the current total range calculated by the current total range calculator when the full-charge detector has detected the full charge as a past total range; and
a display configured to display the instantaneous total range and the past total range such that the instantaneous total range and the past total range are compared with each other.

4. The range display apparatus according to claim 1, further comprising:
a remaining distance calculator configured to calculate a remaining distance to a destination; and
a distance comparator configured to compare the current possible range with the remaining distance,
wherein the display highlights the current possible range if the current possible range is shorter than the remaining distance.

5. The range display apparatus according to claim 1, further comprising:
a remaining distance calculator configured to calculate a remaining distance to a destination; and
a distance comparator configured to compare the instantaneous possible range with the remaining distance,
wherein the display highlights the instantaneous possible range if the instantaneous possible range is shorter than the remaining distance.

6. The range display apparatus according to claim 1,
wherein the display is configured to display the instantaneous total range as a first display bar resulting from addition of a display bar corresponding to the first range to a display bar corresponding to the instantaneous possible range, to display the current total range as a second display bar resulting from addition of a display bar corresponding to the first range to a display bar corresponding to the current possible range, to display the past total range as a third display bar, and to arrange the first to third display bars in parallel on a screen for display.

7. The range display apparatus according to claim 2, further comprising:
a remaining distance calculator configured to calculate a remaining distance to a destination; and
a distance comparator configured to compare the current possible range with the remaining distance,
wherein the display highlights the current possible range if the current possible range is shorter than the remaining distance.

8. The range display apparatus according to claim 3, further comprising:
a remaining distance calculator configured to calculate a remaining distance to a destination; and
a distance comparator configured to compare the current possible range with the remaining distance,
wherein the display highlights the current possible range if the current possible range is shorter than the remaining distance.

9. The range display apparatus according to claim 3, further comprising:
a remaining distance calculator configured to calculate a remaining distance to a destination; and
a distance comparator configured to compare the instantaneous possible range with the remaining distance,
wherein the display highlights the instantaneous possible range if the instantaneous possible range is shorter than the remaining distance.
